(19) United States
(12) Patent Application Publication
(10) Pub. No.: US 2008/0251659 A1
(43) Pub. Date: Oct. 16, 2008

(54) FOLDING STAND FOR LAPTOP COMPUTERS OR OTHER DEVICES

(75) Inventor: Edgar Matias, Toronto (CA)

Correspondence Address: PERRY + CURRIER INC., 1300 YONGE STREET, SUITE 500, TORONTO, ON, M4T-1X3, CA

(73) Assignee: MATIAS CORPORATION, Vaughan (CA)

(21) Appl. No.: 11/735,641

(22) Filed: Apr. 16, 2007

(51) Int. Cl. F16M 11/38

(52) U.S. Cl. 248/166

(57) ABSTRACT

A stand is set forth comprising a support platform, foot portion, a pair of legs; and a plurality of hinges for rotatably connecting the legs between the support platform and the foot portion. Each of the hinges preferably comprises a hinge pin extending from respective ones of the support platform and foot portion and adapted to rotate on at least one fulcrum support extending from each of the pair of legs. A hinge cap preferably encloses and limits rotation of the hinge pin on the at least one fulcrum point.

### BACKGROUND OF THE INVENTION

1. Field of the Invention

The present invention relates generally to portable stands and, more particularly, to a folding stand for supporting laptop computers.

2. Description of the Related Art

Stands for laptops are well known in the art, including stands that are foldable or collapsible into a compact state for storage purposes.

For example, U.S. Pat. No. 5,511,758 discloses a folding stand having two parallel supports joined by a folding brace for supporting a notebook computer. The folding brace includes two bracing bars pivotably joined by a link and pivotably connected between the supports. The supports have a respective sloping top wall for supporting the notebook computer in a tilted position for comfortable operation and an elongated bottom opening for receiving one bracing bar when the folding brace is folded up to collapse the stand.

U.S. Pat. No. 5,607,135 discloses a foldable one-piece tablet stand having a base section, a back rest section which can be raised and lowered into the base section, and a pair of protrusions which can be raised and lowered into the base and disposed at a front part of the base section so that when both the back rest section and protrusions are in the raised conditions, a tablet will be held by the back rest section with a bottom of the tablet held by the base section and secured by the pair of protrusions. A holder section is foldable into the base section and hinged on the back of the back rest section and held on parts of the base section so that the back rest section is fixed thereby.

U.S. Pat. No. 5,915,661 discloses a collapsible desk stand for a portable computer for allowing variation in viewing angles of the computer display, and the ability to connect the portable computer to external, peripheral devices. The portable computer can be positioned on the stand so that both right-handed and left-handed persons can position the portable computer so that data entry is most convenient. The stand includes a feature to allow it to be locked in its collapsed position. An adjustable handstrap assembly is also provided.

U.S. Pat. No. 6,076,787 discloses a portable stand for holding a laptop computer, which is capable of folding to a compact state for storage purposes. The portable stand includes an elongated base member with a pair of base feet to rest on a floor surface, a set of vertically extending post members, and an elongated platform member with a pair of support wings to hold the laptop computer in a position ready for use. The base feet are moveably attached to the elongated base member to swing from a compact position juxtaposed the base member to an extended position at substantially right angles to the base member. The post members are moveably attached to one another, moveably attached to the elongated base member, and moveably attached to the elongated platform member. The base feet and the support wings swing substantially horizontally from the base member and the support member, respectively, while the post members swing substantially vertically relative to one another and to the elongated base and support members.

U.S. Pat. No. 6,505,797 discloses a laptop computer stand adapted to be mounted on a chair or similar vertical structure that includes a horizontal edge. A hanging frame assembly includes a pivotally mounted arched arm at one end that receives the edge of a chair in one extreme position and is retractable within the hanging frame assembly in the other extreme position. The hanging frame assembly is pivotally mounted to the base frame assembly that receives the hanging frame assembly therein is one extreme position and at a substantially rectangular relationship with the hanging frame assembly in the other extreme position. A pivotally mounted leg member is used to raise the base frame assembly to a predetermined angle in one extreme position, and as a spacer in another position while the other extreme position the leg member is housed with the hanging frame space. A retainer member pivotally mounted flange is mounted to the distal end of the base frame assembly to serve as a stopper for a laptop to prevent it from sliding down.

U.S. Pat. No. 6,545,864 discloses a notebook computer stand for a notebook computer, having a U-shaped pocket and a support. The U-shaped pocket receives the relatively thicker frame portion of the notebook computer housing the keyboard, the CPU, the mouse, and related hardware. The notebook computers hinged display is deployed above the pocket for ease of viewing. In one embodiment, the notebook computer stand includes a storage compartment, cable slots for routing cables connected to the notebook computer, and height adjusters for varying the height of the computer stand and, indirectly, the viewing angle of the display.

U.S. Pat. No. 6,682,040 discloses a stand for supporting a laptop computer at different tilt angles. According to one embodiment, a top plate is included having a trapezoidal shape including a number of riser clusters arranged along a narrower parallel side of the top plate. Each one of the riser clusters may be configured to fit within a riser element and hold the riser element. A bottom plate with a trapezoidal shape may be connected to the top plate by a connector that allows the top plate to rotate relative to the bottom plate. A number of laptop supports may be connected to a wider parallel side of the top plate and configured to support one end of the laptop in a slip-resistant manner. At least two riser elements may be stacked respectively on at least two riser clusters. At least two riser caps may be stacked respectively over the at least two riser elements to support an opposite end of the laptop in a slip-resistant resistant manner and at an elevation higher than the one end of the laptop. A variable tilt angle may be imparted by adding or removing riser elements from the stacks to vary convective cooling of the laptop and keyboard tilt.

U.S. Pat. No. 6,819,548 discloses laptop stand having a substantially flat base member that is flexible into a curved configuration for supporting a laptop computer; and at least one brace member, engageable with said the substantially flat base member for retaining the base member in a curved configuration. The base member comprises one or more support elements. The support elements and base member include retaining apertures or slots for fixedly engaging the support elements and base member.

U.S. Pat. No. 7,035,100 discloses an adjustable stand for mounting a notebook or tablet computer comprising a base, a first member mounted on the base, a second member slidably coupled to the first member, and a laptop backboard cradle mounted on the second member. The second member is arcuately slidable with respect to the first member to allow the backboard cradle to be adjustably angled with respect to the base from a fully reclined position to a full height position. Along the sides of base are located a plurality of USB input and output ports, some of which may be powered.

U.S. Pat. D495337 depicts a portable computer stand with an adjustable leg.

### SUMMARY OF THE INVENTION

It is an aspect of the present invention to provide an adjustable support structure for a laptop computer, which permits the computer display to be raised to eye level, and which collapses down flat for travel.

According to another aspect of the invention, the adjustable support structure is constructed so as to provide ventilation for enhanced airflow beneath the laptop, so as to better dissipate heat generated by the laptop during use.

According to a further aspect of the invention, the adjustable support structure is constructed to permit unobstructed access to all side edges of the laptop, so that all data ports or access doors/slots on the laptop are accessible and not blocked.

The adjustable support structure according to an exemplary embodiment is inexpensive to manufacture and easy to assemble, with few component parts.

The above aspects can be attained by a stand, having stand, comprising a support platform; a foot portion; a pair of legs; and a plurality of hinges for rotatably connecting the legs between the support platform and the foot portion.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a stand, in its assembled state, according to an embodiment of the invention.

FIG. 2 is a plan view of the stand in FIG. 1, in its collapsed state.

FIG. 3, comprising FIGS. 3A-3E, shows the stand of FIG. 1 being folded from its assembled state to its collapsed state.

FIG. 4 shows individual components of the stand in FIG. 1.

FIG. 5, comprising FIGS. 5A-5C, is a detail showing assembly of a hinge mechanism of the stand in FIG. 1.

FIG. 6 is a detail of a hinge cap with hinge pin of the stand in FIG. 1.

### DETAILED DESCRIPTION OF THE PREFERRED EMBODIMENTS

An exemplary embodiment of the invention is set forth below. However, a person of skill in the art will appreciate that other embodiments and variations may be possible.

Generally, the support structure of the present invention includes multiple parts connected via a series of hinges to create a stand that is strong, stable, and can be folded completely flat.

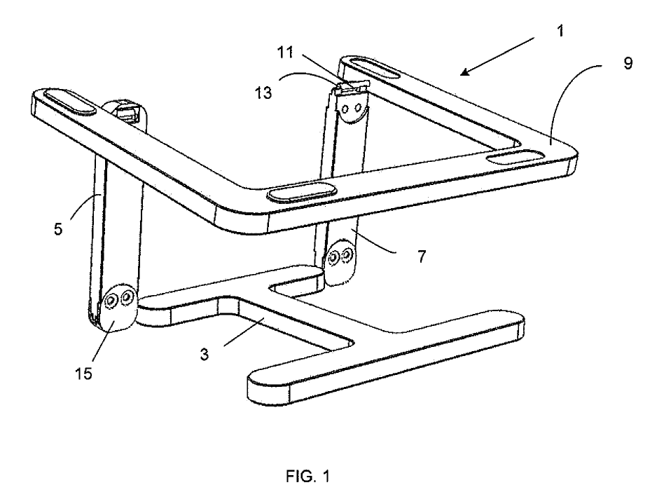

FIG. 1 shows a first embodiment of stand 1 according to the present invention, when fully assembled. The support structure comprises an I-shaped foot 3, two legs 5 and 7, and a C-shaped top platform 9 for supporting a laptop. This design allows air to flow freely beneath and around the laptop for better ventilation, so as to cool the laptop resulting in quieter operation.

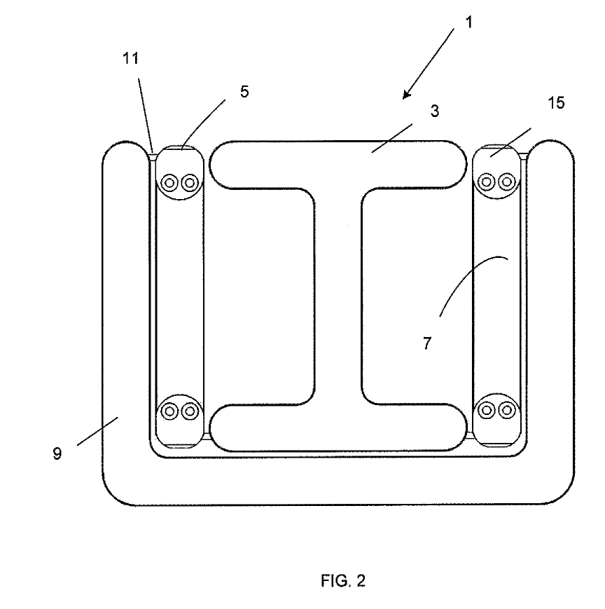

FIG. 2 shows the stand in its folded state, from which it will be noted that none of the support structures overlap each other. Instead, the individual parts 3, 5, 7 and 9 fold beside each other (i.e. coplanar), to minimize the thickness of the stand when in the folded or collapsed state.

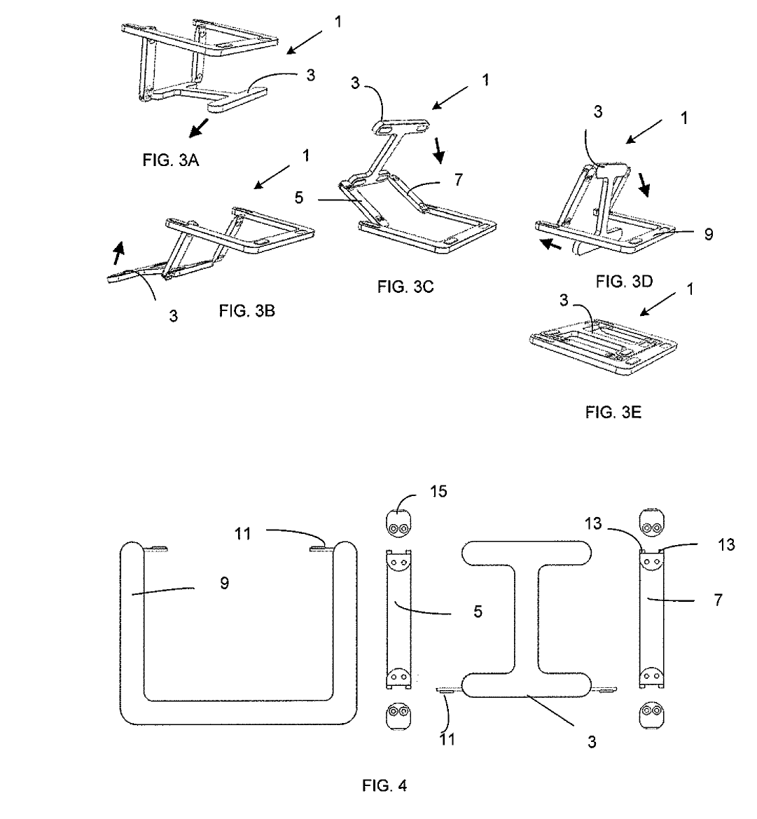

FIG. 3, comprising FIGS. 3A-3E, shows successive stages of the stand 1 being folded flat. The heavy arrows indicate progressive directions of movement of the bottom foot 3, as the stand is folded. In FIG. 3A, the foot 3 is folded down and rearwardly to the position of FIG. 3B. Then, from the position of FIG. 3B, the foot 3 is lifted up so as to also lift up legs 5 and 7 to the position of FIG. 3C. The foot 3 is then folded down through the center of C-shaped top platform 9 (FIG. 3D) and then rearwardly to collapse all of parts 3, 5 and 7 within platform 9 (FIG. 3E). To unfold the stand, simply reverse the process.

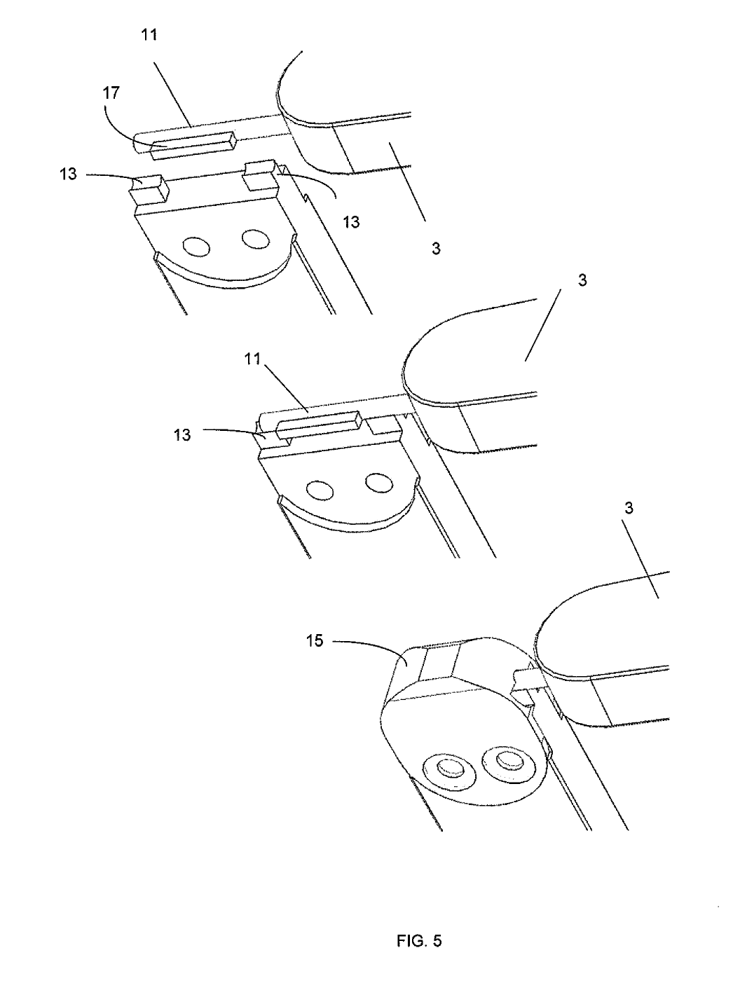

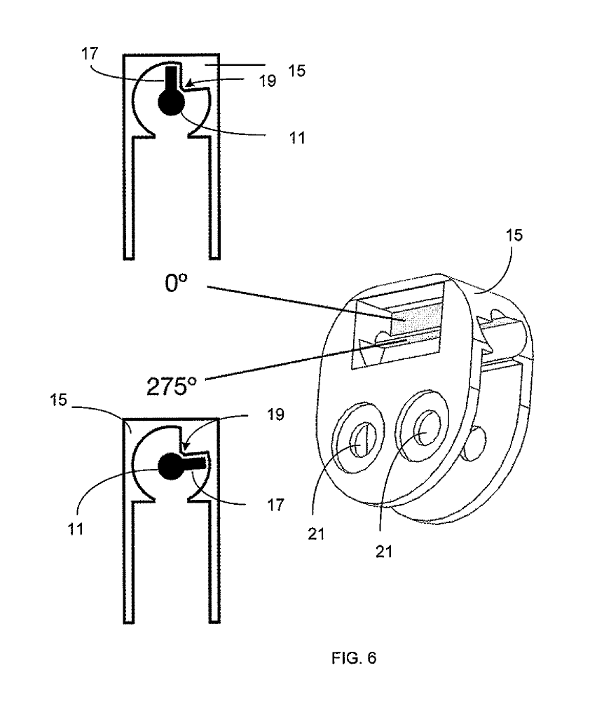

FIG. 4 shows individual components parts of the stand 1, namely the C-shaped support platform 9, I-shaped foot 3, and legs 5 and 7. The foot 3 and platform 9 each include embedded hinge pins 11 that rotate on fulcrum supports 13 extending from the ends of each leg 5 and 7, as discussed in greater detail below with reference to FIG. 6, and are then covered by a hinge cap 15. The hinge cap 15 is omitted from the end of leg 7 in FIG. 1, in order to illustrate pin 11 and fulcrum support 13. If necessary, for example in order to vacillate manufacture, some of the parts discussed above may in turn be manufactured from additional smaller component parts.

As shown in FIG. 5, assembly is easy and quick. First, the fulcrum supports 13 of each leg 5 and 7 are placed against respective hinge pins 11 of foot 3 and platform 9. Next, respective hinge caps 15 are placed over the hinge pins 11 and secured via screws or bolts through holes 21 (FIG. 6) to hold the cap 15 in place.

Together, the hinge pins 11, hinge cap 16, and fulcrum supports 13 of each leg 5 and 7 form a “flag hinge”, which allows the stand 1 to remain upright but also to fold flat as shown in FIG. 3. Most flag hinges rotate freely. However, as shown in FIG. 6, the flag hinge of the present invention limits range of motion (preferably to between about 0 degrees and 275 degrees). This is achieved by providing an internal ledge 17 of hinge pin 11 that rotates on fulcrum supports 13 between opposing edges of a stop abutment 19 within the hinge cap 15.

At zero degrees, the stand 1 is completely flat (i.e. collapsed for storage or transportation). At 275 degrees, the stand 1 is fully deployed and able to support the weight of a laptop on platform 9. Specifically, the weight of a laptop on platform 9 pushes downwardly on the hinges but movement past the 275 degree limit is prevented by stop abutment 19, such that the laptop is held in place and stabilizes the stand. For example, if the user accidentally pushes the laptop forward while on the stand 1 to, say 260 degrees, the weight of the laptop pulls the stand 1 back to 275 degrees, thus preventing the laptop from falling over.

Although the 0 degrees-275 degrees range of movement is preferred for the exemplary embodiment set forth herein, other angles are also possible.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A stand, comprising:
a support platform;
a foot portion;
a pair of legs; and
a plurality of hinges for rotatably connecting said legs between said support platform and said foot portion.

2. The stand of claim 1, wherein each of said hinges comprises a hinge pin extending from respective ones of said support platform and foot portion and adapted to rotate on at least one fulcrum support extending from each of said pair of legs, and a hinge cap enclosing and limiting rotation of said hinge pin on said at least one fulcrum point.

3. The stand of claim 2, wherein said hinge pin includes a ledge for limiting rotation on said fulcrum supports between opposing edges of a stop abutment within the hinge cap.

4. The stand of claim 3, wherein said stop abutment defines an approximate 0 to 275 degrees range of rotation of each of said hinges, whereby said stand is collapsed flat when said hinges are rotated to 0 degrees and said stand is expanded to a weight bearing configuration when said hinges are rotated to 275 degrees.

5. The stand of claim 1, wherein said support platform is generally C-shaped for receiving said foot portion and pair of legs within an opening thereof whereby said stand may be folded flat.

6. A method of collapsing a stand having a generally C-shaped support platform, a foot portion, a pair of legs, and a plurality of hinges for rotatably connecting said legs between said support platform and said foot portion, comprising:
folding said foot portion down and rearwardly behind said leg portion;
lifting said foot portion above said support platform foot portion so as to lift said leg portions;
folding said foot portion down through an opening in said C-shaped support platform and then rearwardly to collapse said foot portion and leg portions within said support platform such that said stand is folded flat.
